(19) United States
(12) Patent Application Publication
(10) Pub. No.: US 2022/0166910 A1
(43) Pub. Date: May 26, 2022

(54) GIMBAL CONTROL METHOD, GIMBAL AND COMPUTER READABLE STORAGE MEDIUM

(71) Applicant: SZ DJI TECHNOLOGY CO., LTD., Shenzhen (CN)

(72) Inventors: Xianmao CHANG, Shenzhen (CN); Shuai LIU, Shenzhen (CN); Yingzhi WANG, Shenzhen (CN)

(73) Assignee: SZ DJI TECHNOLOGY CO., LTD., Shenzhen (CN)

(21) Appl. No.: 17/669,371

(22) Filed: Feb. 11, 2022

Related U.S. Application Data
(63) Continuation of application No. PCT/CN2019/100337, filed on Aug. 13, 2019.

(51) Int. Cl. H04N 5/232; G05D 3/20; F16M 11/12; F16M 13/04

(52) U.S. Cl. CPC H04N 5/2328; G05D 3/20; H04N 5/23251; F16M 13/04; F16M 11/123

(57) ABSTRACT

A gimbal control method, a gimbal and a computer-readable storage medium including the gimbal control method are provided. The gimbal control method may include determining a target attitude angle of a gimbal, determining an attitude deviation value of the gimbal based on the target attitude angle and a current attitude angle of a clamping portion of the gimbal, generating a corresponding centering control instruction based upon the attitude deviation value, and executing the centering control instruction to control the gimbal to return to a center position.

### CROSS-REFERENCE TO RELATED APPLICATION

The present application is a continuation of International Application No. PCT/CN2019/100337, filed Aug. 13, 2019, the entire contents of which being incorporated herein by reference in its entirety.

### TECHNICAL FIELD

The present disclosure relates to the technical field of gimbal control, and more particularly, to a gimbal control method, a gimbal, and a computer readable storage medium.

### BACKGROUND

People take pictures and videos using an electronic device such as a digital camera, for example, a compact camera, an SLR camera, a video camera, a camcorder, etc. or a smart phone. However, since taking pictures or videos is generally manually controlled by a user, it is prone to shaking, jitter or imbalance, resulting in unsmooth and blurred pictures. To improve the quality of pictures, the camera or smart phone may be mounted to a photographing stabilizer, such as a handheld gimbal, to automatically adjust an attitude of the camera or smart phone according to user's actions to keep the picture stable.

During the operation of a handheld gimbal, in order to facilitate a user to use the handheld gimbal, it is usually necessary to control the handheld gimbal to return to the attitude zero position, i.e., to control the handheld gimbal to return to center. However, it is difficult to use a traditional centering control method of the handheld gimbal to control the handheld gimbal to return to center accurately and safely.

### SUMMARY

The present disclosure is directed to a gimbal control method, a gimbal, and a computer-readable storage medium, aiming at accurately and safely controlling the gimbal to return to center.

According to a first aspect of the present disclosure, a gimbal control method for a gimbal is provided, the gimbal control method including:

determining a target attitude angle of the gimbal based upon a current control mode of the gimbal, a current attitude angle of a handle portion of the gimbal, and a current attitude angle of a clamping portion of the gimbal, the target attitude angle being an attitude angle of the gimbal when a centering is completed;

determining an attitude deviation value of the gimbal based upon the target attitude angle and the current attitude angle of the clamping portion, and generating a corresponding centering control instruction based upon the attitude deviation value, and

executing the centering control instruction to control the gimbal to return to center until an attitude angle of the clamping portion is the target attitude angle after the centering.

According to a second aspect of the present disclosure, a gimbal control method for a handheld gimbal is provided, the handheld gimbal is provided with a centering control key; the gimbal control method may include:

acquiring a trigger operation of a user on the centering control key;

generating a gimbal centering instruction corresponding to the trigger operation based upon the acquired trigger operation of the user on the centering control key, the gimbal centering instruction being used to control the handheld gimbal to return to center; and

according to the gimbal centering instruction, controlling the handheld gimbal to return to center.

According to a third aspect of the present disclosure, a gimbal is provided. The gimbal may include a clamping portion, a handle portion, and at least one set of shaft assembly, the shaft assembly including a motor and a shaft arm, the motor being connected to the shaft arm for driving the shaft arm to rotate, the shaft arm being connected to the clamping portion, and the clamping portion rotating with the rotation of the shaft arm; and the gimbal further includes one or more processors, at least one of the one or more processors is configured to communicatively connect to the motor, wherein the one or more processors are, individually or collectively, configured to:

determine a target attitude angle of the gimbal based upon a current control mode of the gimbal, a current attitude angle of the handle portion of the gimbal and a current attitude angle of the clamping portion of the gimbal, the target attitude angle being an attitude angle of the gimbal when a centering is completed:

determine an attitude deviation value of the gimbal based upon the target attitude angle and the current attitude angle of the clamping portion, and generate a corresponding centering control instruction based upon the attitude deviation value; and

execute the centering control instruction to control the gimbal to return to center until an attitude angle of the clamping portion is the target attitude angle after the centering.

According to a fourth aspect of the present disclosure, a gimbal is further provided. The gimbal may include a centering control key and one or more processors, at least one of the one or more processors configured to communicatively connect to the centering control key, wherein the one or more processors are, individually or collectively, configured to:

acquire a trigger operation of a user on the centering control key;

generate a gimbal centering instruction corresponding to the trigger operation based upon the acquired trigger operation of the user on the centering control key, where the gimbal centering instruction is used to control the gimbal centering to return to center; and

control the gimbal to return to center according to the gimbal centering instruction.

According to a fifth aspect of the present disclosure, a computer-readable storage medium having stored a computer program thereon that, when executed by a processor, cause the processor to implement the gimbal control methods described above, is also provided.

Thus, the present disclosure provides a gimbal control method, a gimbal, and a computer-readable storage medium. Based upon a current control mode of the gimbal, a current attitude angle of a handle portion of the gimbal and a current attitude angle of a clamping portion of the gimbal, an attitude angle of the gimbal when a centering is completed may be accurately determined. Based on the determined attitude angle of the gimbal and the current attitude angle of the clamping portion, a centering control instruction for controlling the gimbal to return to center may be generated and then executed to enable the gimbal to perform the centering function smoothly without tremor in any attitude, which effectively reduces the problems of the gimbal throwing, hitting the upper limit, system crashing, etc., and can accurately and safely control the gimbal to return to center.

It should be understood that the foregoing general description and the following detailed description are exemplary and explanatory only and are not restrictive of the present disclosure.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 illustrates a schematic structural diagram of a handheld gimbal for implementing a gimbal control method of the present disclosure according to some embodiments of the present disclosure.

FIG. 2 illustrates a schematic flowchart of a gimbal control method according to some embodiments of the present disclosure.

FIG. 3 illustrates a schematic flowchart of sub-steps of the gimbal control method of FIG. 2 according to some embodiments of the present disclosure.

FIG. 4 illustrates a schematic flowchart of sub-steps of the gimbal control method of FIG. 2 according to some embodiments of the present disclosure.

FIG. 5 illustrates a schematic flow diagram of controlling mode switching and centering of a gimbal according to some embodiments of the present disclosure.

FIG. 6 illustrates a schematic flowchart of a gimbal control method according to some embodiments of the present disclosure.

FIG. 7 illustrates a schematic structural block diagram of a gimbal according to some embodiments of the present disclosure.

FIG. 8 illustrates a schematic structural block diagram of a gimbal according to some embodiments of the present disclosure.

### DETAILED DESCRIPTION

The technical solutions and technical features encompassed in the exemplary embodiments of the present disclosure will be described clearly and fully in conjunction with the accompanying drawings in the exemplary embodiments of the present disclosure. Apparently, the described exemplary embodiments are part of embodiments of the present disclosure, not all of the embodiments. Based on the embodiments and examples disclosed in the present disclosure, all other embodiments obtained by those of ordinary skill in the art without inventive efforts shall fall within the protection scope of the present disclosure.

Here, exemplary embodiments will be described in detail, and examples thereof are shown in the accompanying drawings. The implementation manners described in the following exemplary embodiments do not represent all implementation manners consistent with the present disclosure. On the contrary, they are only examples of devices and methods consistent with some aspects of the disclosure as detailed in the appended claims. Further, the chart(s) and diagram(s) shown in the drawings are only examples, and does not necessarily include all components, elements, contents and/or operations/steps, nor does it have to be arranged in the described or specific order. For example, some components/elements can also be disassembled, combined or partially combined; therefore, the actual arrangement may be changed or modified according to actual conditions. In the case of no conflict, the components, elements, operations/steps and other features disclosed in the embodiments may be recombined with each other.

Embodiments of the present disclosure provide a gimbal control method, which may be applied to a photographing stabilizer, for example, the photographing stabilizer may be a handheld gimbal. The gimbal control method may control rotation of motors of the handheld gimbal to adjust an attitude of the gimbal, for example, to control the gimbal to return to a center position or an attitude zero position. The gimbal control method may solve the traditional centering problem of the gimbal in a complex attitude combination when controlling the gimbal to return to center by fully considering the shortest path, the mechanical limit and some other limiting factors that may affect a centering function of the gimbal. In this way, the gimbal control method ensures that the centering function of the gimbal may be implemented normally under any attitude combination, and the whole centering process is carried out smoothly and fluidly without tremor, which greatly improves the user experience.

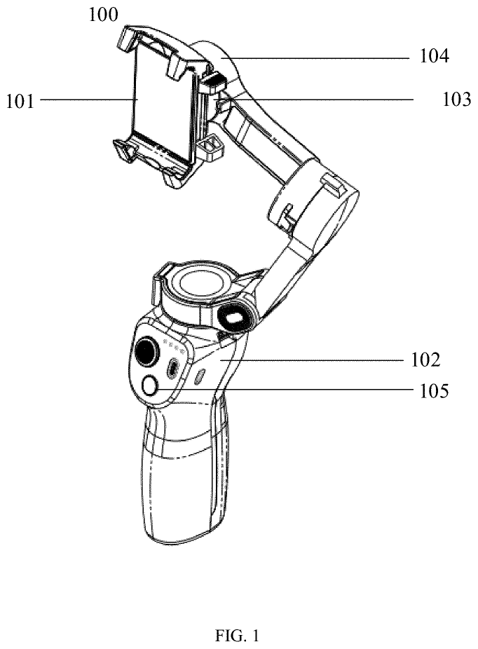

FIG. 1 illustrates a schematic structural diagram of a handheld gimbal for implementing a gimbal control method of the present disclosure according to some embodiments of the present disclosure. As shown in FIG. 1, the handheld gimbal 100 may include a clamping portion 101, a handle portion 102, a rotating shaft 103, a motor 104, and a centering control key 105. The clamping portion 101 is used to clamp a photographing device, such as a smart phone and/or a camera. In certain embodiments, the clamping portion 101 may also be integrated with a photographing device. The motor 104 is connected to the rotating shaft 103 for driving the rotating shaft 103 to rotate. The rotating shaft 103 is connected to the clamping portion 101, and the clamping portion 101 rotates as the rotating shaft 103 rotates. The centering control key 105 is used to control the handheld gimbal 100 to return to center, the centering control key 105 may also be used to control the handheld gimbal 100 to turn on or off, and the centering control key 105 may also be used to control the mode switching of the handheld gimbal 100, such as to switch among a flashlight mode, a suspension mode, a horizontal shooting (landscape-shooting) mode and a vertical shooting (portrait-shooting) mode. The centering control key 105 may include at least one of a press control key, a joystick control key, a slide control key, or a click control key. Hereinafter, some embodiments of the present disclosure will be further described in detail with reference to the accompanying drawings. In the case of no conflict, the following examples and features in the embodiments may be recombined with each other.

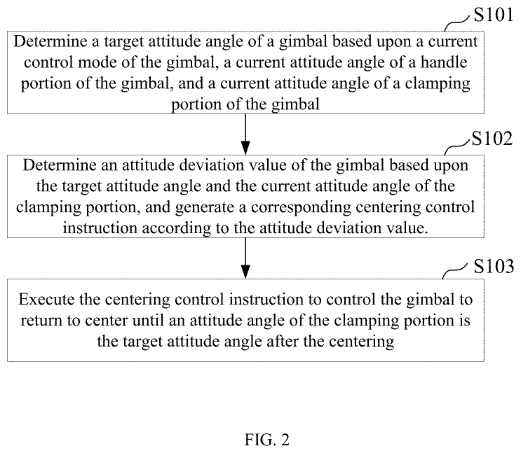

FIG. 2 illustrates a schematic flowchart of a gimbal control method according to some embodiments of the present disclosure. The gimbal control method may be applied to a handheld gimbal to control accurate and safe return-to-center of the handheld gimbal. As shown in FIG. 2, the gimbal control method may include step S101 to step S103.

Step S101 may include determining a target attitude angle of a gimbal based upon a current control mode of the gimbal, a current attitude angle of a handle portion of the gimbal, and a current attitude angle of a clamping portion of the gimbal.

In some embodiments, the gimbal is a handheld gimbal with a non-orthogonal structure. The handheld gimbal may include a handle portion, a clamping portion and at least one set of shaft assembly. The shaft assembly may include a motor and a shaft arm. The motor is connected to the shaft arm and used to drive the shaft arm to rotate. The shaft arm is connected to the clamping portion that rotates with the rotation of the shaft arm. The clamping portion is used to mount an imaging equipment such as a smart phone, a camera, a camcorder, or the like.

In certain embodiments, the handheld gimbal determines a target attitude angle of the handheld gimbal based upon a current control mode of the handheld gimbal, a current attitude angle of the handle portion of the handheld gimbal and a current attitude angle of the clamping portion of the handheld gimbal. The target attitude angle is an attitude angle of the handheld gimbal when centering is completed. In one embodiment, the clamping portion is provided with an inertial measurement unit, the current attitude angle of the clamping portion may be determined by the inertial measurement unit, and the current attitude angle of the handle portion may be determined based on the current attitude angle of the clamping portion. In another embodiment, the clamping portion and the handle portion are each provided with an inertial measurement unit, and the current attitude angle of the clamping portion and the current attitude angle of the handle portion may be determined by their corresponding inertial measurement units. By arranging the inertial measurement unit at the clamping portion and not at the handle portion, the cost of the gimbal may be reduced, and the attitude angles of the clamping portion and the handle portion may be obtained accurately. However, by providing both the clamping portion and the handle portion inertial measurement units, the attitude angle of the handle portion may be obtained without complicated calculations, which may enable the handheld gimbal to quickly acquire the attitude angles of the clamping portion and the handle portion.

In some embodiments, the handheld gimbal acquires a gimbal centering instruction in real time or at predetermined time intervals. The gimbal centering instruction is used to control the gimbal centering, i.e., returning to center. When the gimbal centering instruction is acquired, the current control mode of the handheld gimbal, the current attitude angle of the handle portion and the current attitude angle of the clamping portion are obtained based upon the gimbal centering instruction. Through a real-time or timed detection to acquire the gimbal centering instruction, the gimbal centering instruction may be acquired timely and accurately, which is convenient for subsequent timely and accurate control of the gimbal centering.

In one embodiment, a control mode tag is obtained from the gimbal centering instruction, and a control mode corresponding to the control mode tag is used as the current control mode of the handheld gimbal. An attitude angle output, at the current time, by the inertial measurement unit provided at the clamping portion of the handheld gimbal is acquired. The acquired attitude angle output by the inertial measurement unit is used as the current attitude angle of the clamping portion. Joint angle data output by an encoder at the current time is further acquired, and the current attitude angle of the handle portion is calculated based on the joint angle data and the current attitude angle of the clamping portion. In this way, by arranging the inertial measurement unit at the clamping portion, and not at the handle portion, the cost of the gimbal is reduced, but accurate attitude angles of the clamping portion and the handle portion may be obtained.

In another embodiment, a control mode tag is obtained from the gimbal centering instruction, and a control mode corresponding to the control mode tag is used as the current control mode of the handheld gimbal. An attitude angle output by a first inertial measurement unit at the current moment and an attitude angle output by a second inertial measurement unit at the current moment are acquired. The attitude angle output by the first inertial measurement unit at the current moment is used as the current attitude angle of the clamping portion of the handheld gimbal, and the attitude angle output by the second inertial measurement unit at the current moment is used as the current attitude angle of the handle portion of the handheld gimbal. In this way, by arranging the inertial measurement units at both the clamping portion and the handle portion, the attitude angle of the handle portion may be obtained without complicated calculations, and the attitude angles of the clamping portion and the handle portion may be quickly obtained.

In yet another embodiment, the handheld gimbal may detect an attitude angle change process of the handle portion. When it is detected that the attitude angle change process of the handle portion satisfies a preset handle attitude angle change mode, a gimbal centering instruction is automatically triggered and then obtained. Alternatively, the handheld gimbal detects the attitude angle change process of the handle portion. When it is detected that the attitude angle change process of the handle portion satisfies the preset handle attitude angle change mode, and an attitude angle of the clamping portion changes along with the attitude angle change process of the handle portion, the gimbal centering instruction will be automatically triggered and then obtained. It should be noted that the preset handle attitude angle change mode may be set based on actual conditions, which are not specifically limited in the present disclosure. For example, in one embodiment, the handle attitude angle change mode is that a joint angle of a middle frame motor of the gimbal moves more than 40 degrees.

In one embodiment, the handheld gimbal is provided with a centering control key. A user may manually trigger a gimbal centering instruction through the centering control key. For example, a trigger operation of the user on the centering control key is acquired. When the trigger operation on the center control key satisfies a preset trigger operation, the gimbal centering instruction is triggered, and the gimbal centering instruction is then acquired. The centering control key may include at least one of a press control key, a joystick control key, a slide control key, or a click control key. The trigger operation may include at least one of a press operation, a joystick operation, a sliding operation or a click operation. It should be noted that the preset trigger operation and the location of the centering control key may be set based on actual conditions, which are not specifically limited in this disclosure. For example, the centering control key may be arranged at the handle portion of the gimbal. By providing the centering control key, it is convenient for a user to control the handheld gimbal to return to center with one key, which improves the convenience of centering control and effectively improves the user experience.

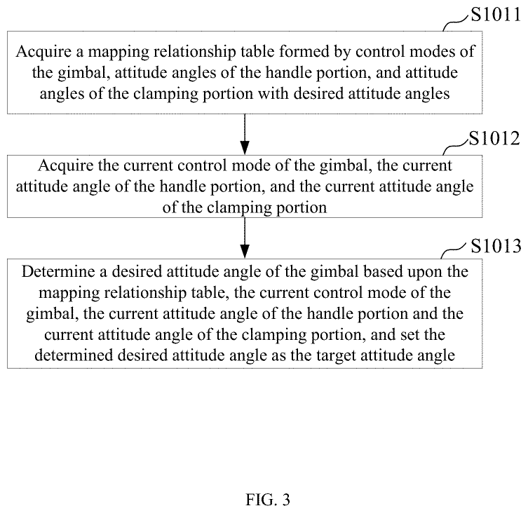

In some embodiments, as shown in FIG. 3, step S101 may further include sub-step S1011 to sub-step S1013.

Sub-step S1011 may include acquiring a mapping relationship table formed by control modes of the gimbal, attitude angles of the handle portion, and attitude angles of the clamping portion with desired attitude angles.

In certain embodiments, the handheld gimbal may store a mapping relationship table formed by control modes of the gimbal, attitude angles of the handle portion of the gimbal and attitude angles of the clamping portion of the gimbal with desired attitude angles. The control modes of the gimbal, the attitude angles of the handle portion of the gimbal, and the attitude angles of the clamping portion of the gimbal have a corresponding relationship with the desired attitude angles. The desired attitude angle is a desired attitude angle of the handheld gimbal when a centering is completed.

Sub-step S1012 may include acquiring the current control mode of the gimbal, the current attitude angle of the handle portion, and the current attitude angle of the clamping portion.

In certain embodiments, the handheld gimbal may acquire the current control mode, obtain the current attitude angle of the clamping portion through an inertial measurement unit provided at the clamping portion, acquire joint angle data output by an encoder, and compute the current attitude angle of the handle portion based on the current attitude angle of the clamping portion and the joint angle data. In other embodiments, the current attitude angle of the clamping portion and the current attitude angle of the handle portion are obtained through inertial measurement units respectively provided at the clamping portion and the handle portion.

Sub-step S1013 may include determining a desired attitude angle of the gimbal based upon the mapping relationship table, the current control mode of the gimbal, the current attitude angle of the handle portion and the current attitude angle of the clamping portion, the desired attitude angle being used as the target attitude angle.

In certain embodiments, the handheld gimbal may query the mapping relationship table to acquire the desired attitude angle corresponding to the current control mode of the gimbal, the current attitude angle of the handle portion and the current attitude angle of the clamping portion, and set the acquired desired attitude angle as the target attitude angle of the gimbal. By setting-up the mapping relationship table formed by the control modes of the gimbal, the attitude angles of the handle portion and the attitude angles of the clamping portion with the desired attitude angles, the attitude angle of the gimbal after centering may be determined quickly and accurately based on the current attitude angles and mode of the gimbal, which facilitates the subsequent control of the gimbal returning to center. It should be noted that the mapping relationship table formed by the control modes of the gimbal, the attitude angles of the handle portion, and the attitude angles of the clamping portion with the desired attitude angles can be constructed based on actual conditions, which are not specifically limited in the present disclosure.

For example, relative to the gravity direction of the handle portion, attitudes of the handle portion may be categorized into upright, inverted, 90° left-tilt, 90° right-tilt, 90° forward, and 90° backward, a total of six states, while attitudes of the clamping portion may be categorized into four states: upright, inverted, 90° forward and 90° backward. It needs to be clarified, however, that the categorization of the attitudes of the clamping portion does not consider the rotation about the ROLL axis, which is mainly related to the switching between horizontal shooting and vertical shooting. In the case of ignoring a joint angle limit, the handle portion and the clamping portion may have 24 combinations of attitudes. By separately discussing the centering controls under these 24 combinations, the correctness of functions can be ensured. Control modes may also be classified into five control modes: normal, upper flashlight, lower flashlight, left vertical-shooting, and right vertical-shooting. There will be different treatments under different control modes. In practice, some of the controls under these 24 attitude combinations are universal. Thus, the attitudes are controlled to return to their attitude zero positions as much as possible when they can return to the attitude zero positions. At the same time, returning to the kind of attitude that a user wants the gimbal to return to from the current attitude is also considered to satisfy the user's expectations as much as possible. Under those considerations, the mapping relationship table between the control modes of the gimbal, the attitude angles of the handle portion and the attitude angles of the clamping portion, and the desired attitude angles is constructed.

Table 1 is a mapping relationship table between control modes of the gimbal, attitude angles of the handle portion, and attitude angles of the clamping portion, and desired attitude angles according to some embodiments of the present disclosure.

The method for determining the desired attitude angle may include: determining a desired attitude angle tag based upon the current control mode of the gimbal, the current attitude angle of the handle portion and the current attitude angle of the clamping portion, that is, obtaining a first tag corresponding to the current control mode of the gimbal, a second tag corresponding to the current attitude angle of the handle portion, and a third tag corresponding to the current attitude angle of the clamping portion, splicing the first tag, the second tag and the third tag to obtain a spliced tag, and taking the spliced tag as the desired attitude angle tag, based upon the mapping relationship table, taking an attitude angle corresponding to the determined desired attitude angle tag as the desired attitude angle of the gimbal, that is, querying the mapping relationship table to obtain a desired attitude angle corresponding to the desired attitude angle tag, and taking the obtained desired attitude angle as the desired attitude angle of the gimbal. Through the desired attitude angle tag and the mapping relationship table, the desired attitude angle of the gimbal may be quickly determined, which ultimately speeds up the centering process.

TABLE 1
A mapping relationship table of control modes of a gimbal, attitude angles of a handle
portion of the gimbal, and attitude angles of a clamping portion of the gimbal, and desired.
attitude angles.

| Clamping portion | | | | | |
|---|---|---|---|---|---|
| Control | Handle | | | | |
| Mode | portion | Upright | Inverted. | 90° Forward | 90° Backward |
| Normal | Upright | Return NCH axis to the attitude zero position | | | |
| Mode | | Return YAW axis to the attitude zero position | | | |
| | Inverted | Return PICH axis to | Return PICH axis to the attitude | | |
| | | the attitude zero | 180° position | | |
| | | position | | | |
| | | Return YAW axis to | Return YAW axis to the attitude | | |
| | | the attitude 180° | 180° position | | |
| | | position | | | |
| Flashlight | 90° Forward | Return PICH axis to the zero position of the middle frame joint angle | | | |
| Mode | 90° Backward | Return YAW axis to an angle closest to the current inner frame joint angle | | | |
| | 90° Left-tilt | among the zero position, ±90° positions and ±180° positions of the inner | | | |
| | 90° Right-tilt | frame joint angle | | | |
| Vertical- | 90° Forward | Return PICH axis to the attitude | | Return PICH | Return PICH |
| shooting | 90° Backward | zero position | | axis to the | axis to the |
| Mode | 90° Left-tilt | Return YAW axis to the zero | | attitude zero | attitude zero |
| | 90° Right-tilt | position of the middle frame joint | | position | position |
| | | angle | | Return YAW | Return YAW |
| | | | | axis to an angle | axis to an angle |
| | | | | closest to the | closest to the |
| | | | | current inner | current inner |
| | | | | frame joint | frame joint |
| | | | | angle among the | angle among the |
| | | | | zero position, | zero position, |
| | | | | ±90° positions | ±90° positions |
| | | | | and ±180° | and ±180° |
| | | | | positions of the | positions of the |
| | | | | inner frame | inner frame |
| | | | | joint angle | joint angle |

It should be noted that the splicing manner of the first tag, the second tag, and the third tag can be set based on actual conditions, which are not specifically limited in the present disclosure. In one embodiment, it may be spliced in the order of the first tag, the second tag, and the third tag. For example, if the first tag is 01, the second tag is 101, and the third tag is 011, the desired attitude angle tag obtained by splicing is 01101011.

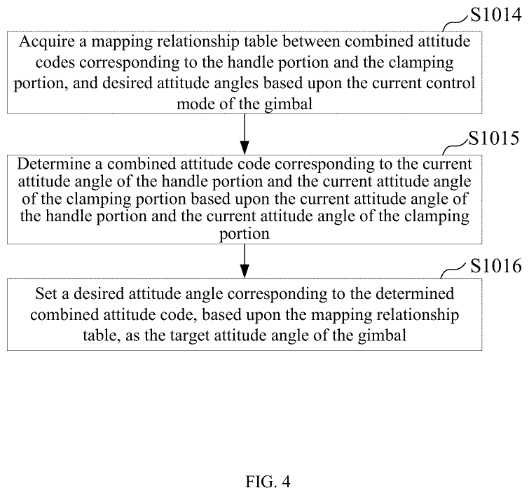

In some embodiments, as shown in FIG. 4, step S101 may include sub-step S1014 to sub-step S1016.

Sub-step S1014 may include acquiring a mapping relationship table between combined attitude codes corresponding to the handle portion and the clamping portion, and desired attitude angles based upon the current control mode of the gimbal.

In certain embodiments, the handheld gimbal may store the mapping relationship table between the combined attitude codes corresponding to the handle portion and the clamping portion and the corresponding desired attitude angles. A control mode of the handheld gimbal has a corresponding relationship with a mapping relationship table, that is, different control modes correspond to different mapping relationship tables. Based upon the current control mode, the handheld gimbal acquires a corresponding mapping relationship table between combined attitude codes corresponding to the handle portion and the clamping portion and desired attitude angles.

Sub-step S1015 may include determining a combined attitude code corresponding to the current attitude angle of the handle portion and the current attitude angle of the clamping portion based upon the current attitude angle of the handle portion and the current attitude angle of the clamping portion.

In certain embodiments, the handheld gimbal acquires the current attitude angle of the handle portion and the current attitude angle of the clamping portion, and based on the current attitude angle of the handle portion and the current attitude angle of the clamping portion, determines a corresponding combined attitude code. That is, the handheld gimbal acquires a first attitude code corresponding to the current attitude angle of the handle portion and a second attitude code corresponding to the current attitude angle of the clamping portion, splice the first attitude code and the second attitude code to obtain a spliced attitude code, and takes the spliced attitude code as the combined attitude code. It should be noted that the splicing manner of the first attitude code and the second attitude code can be set based on actual conditions, which are not specifically limited in the present disclosure. In one embodiment, the second attitude code and the first attitude code are spliced in the order, for example, if the first attitude code is 11 and the second attitude code is 10, the combined attitude code obtained by splicing is 1011.

Sub-step S1016 may include setting a desired attitude angle corresponding to the determined combined attitude code, based upon the mapping relationship table, as the target attitude angle of the gimbal.

In certain embodiments, the mapping relationship table is queried, the desired attitude angle corresponding to the combined attitude code is acquired, and the acquired desired attitude angle is used as the target attitude angle of the gimbal. In this way, taking the control mode as a unit and storing the mapping relationship table between the combined attitude codes corresponding to the handle portion and the clamping portion and the corresponding desired attitude angles facilitates accurately determining the target attitude angle of the gimbal by a quick query of the mapping relationship table based on the control mode, which is convenient to subsequently control the gimbal back to center accurately and safely.

Step S102 may include determining an attitude deviation value of the gimbal based upon the target attitude angle and the current attitude angle of the clamping portion and generating a corresponding centering control instruction based upon the attitude deviation value.

In some embodiments, after determining the target attitude angle of the gimbal, the handheld gimbal may determine an attitude deviation value of the gimbal based on the target attitude angle and the current attitude angle of the clamping portion, and generate a corresponding centering control instruction based upon the attitude deviation value. In certain embodiment, a difference between the target attitude angle and the current attitude angle of the clamping portion is calculated and used as the attitude deviation value of the gimbal. A pre-stored mapping relationship table between attitude deviation values and centering speeds is acquired, and a centering speed corresponding to the determined attitude deviation value is further acquired by querying the mapping relationship table. Based on the acquired centering speed, the corresponding centering control instruction is generated. It should be noted that the mapping relationship table between the attitude deviation values and the centering speeds can be set based on actual conditions, which are not specifically limited in the present disclosure.

Step S103 may include executing the centering control instruction to control the gimbal to return to center until an attitude angle of the clamping portion is the target attitude angle after the centering.

In some embodiments, the handheld gimbal may execute the centering control instruction to control the centering of the gimbal, that is, the handheld gimbal may determine a motor to be rotated based on the centering control instruction. Based upon the centering speed in the centering control instruction, the determined motor is controlled to rotate at a uniform speed, and to drive the clamping portion to rotate while the determined motor rotates, thereby changing an attitude angle of the clamping portion. When the attitude angle of the clamping portion is the target attitude angle after returning to center, the gimbal completes the centering. By controlling the motor to rotate at a constant speed, the gimbal may be controlled to return to center smoothly without tremor, which greatly improves the user experience.

In certain embodiments, in the process of controlling the centering of the gimbal, the centering speed in the centering control instruction may be updated, and the motor may be controlled to rotate based upon the updated centering speed, and accordingly the centering of the gimbal may be controlled at a variable speed. In one embodiment, in the process of controlling the centering of the gimbal, a centering deviation value of the gimbal is determined based upon the target attitude angle and the attitude angle of the gimbal after centering at a predetermined time interval. Then, whether the centering deviation value is greater than a preset threshold is further determined. When the centering deviation value is greater than the preset threshold, the centering control instruction will be updated based upon the centering deviation value, and the updated centering control instruction will be executed to control the centering of the gimbal. When the centering deviation value is less than or equal to the preset threshold, it is determined that the attitude angle of the clamping portion after centering is the target attitude angle, and the gimbal is controlled to end the centering. By updating the centering speed in the centering control instruction at the predetermined time interval, the motor can be accelerated while ensuring stability, which may speed the centering, reduce the user waiting time, and greatly improve the user experience.

The updating method of the centering control instruction may be as follows: the handheld gimbal acquires a pre-stored mapping relationship table between centering deviation values and centering speeds; according to the mapping relationship table, the centering speed corresponding to the determined centering deviation value is taken as the centering speed of the gimbal, i.e., by querying the mapping relationship table, the centering speed corresponding to the determined centering deviation value is acquired, and the acquired centering speed is used as the updated centering speed of the gimbal; the centering control instruction is updated based upon the updated centering speed of the gimbal, that is, the centering speed in the centering control instruction is updated to the updated centering speed of the gimbal. It should be noted that the greater the centering deviation value is, the higher the centering speed is, and the smaller the centering deviation value is, the lower the centering speed is.

In one embodiment, before updating the centering control instruction, whether the centering speed of the gimbal is less than a preset speed threshold is determined. If the centering speed of the gimbal is less than the preset speed threshold, the centering control instruction is updated based on the centering speed of the gimbal. It should be noted that the preset speed threshold is the maximum value that the centering speed may reach under conditions that the centering is stable, which may be obtained through experiments. By setting the maximum value that the centering speed can reach, it may prevent the gimbal from being damaged or unstable due to the high speed during the centering process, which improves the accuracy and safety of the centering.

In one embodiment, during the centering process of the handheld gimbal, a centering duration of the gimbal is recorded and evaluated to determine whether the centering duration is greater than a preset time threshold. When the centering duration is greater than the preset time threshold, the gimbal is controlled to end the centering. It should be noted that the preset time threshold can be set based on actual conditions, which are not specifically limited in the present disclosure. By setting a time threshold for the centering duration, the centering may be forced to end when the centering duration exceeds the time threshold, preventing problems such as damage to the gimbal due to the timeout of the centering, and improving the accuracy of the centering.

In another embodiment, for example, the control instruction of the handheld gimbal is a ZXYX control instruction, that is, the handheld gimbal performs an additional X-axis rotation following the traditional ZXY sequence, which is denoted as ROLL2, and the ZXYX control instruction is YAW, ROLL, PITCH and ROLL2. ROLL2 is used for horizontal and vertical shooting control. ROLL2 is 0° in a horizontal shooting mode, and 90° in a vertical shooting mode. Since ROLL2 is the last to rotate about X axis, it will not affect the normal ROLL, PITCH, YAW instructions. The only difference between a horizontal shooting and a vertical shooting is whether ROLL2 control is required, so when controlling the gimbal to return to center, there is no need to distinguish horizontal and vertical shootings. It simplifies the control logic of the centering, greatly improving the speed of the centering, and effectively improving the user experience.

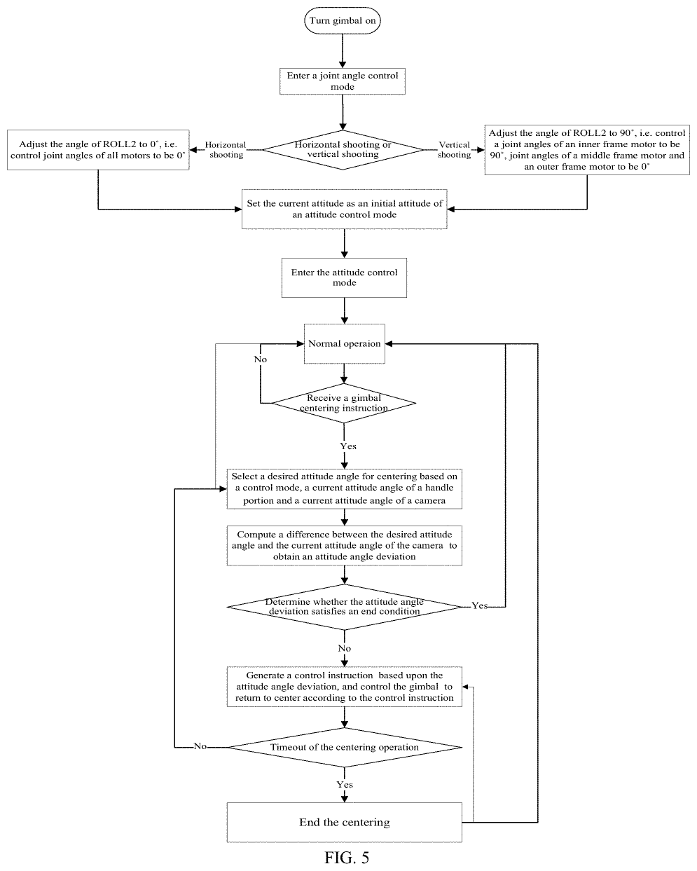

FIG. 5 illustrates a schematic flow diagram of controlling mode switching and centering of a gimbal according to some embodiments of the present disclosure. As shown in FIG. 5, when the gimbal is turned on, it automatically enters a joint angle control mode to determine a shooting mode of the gimbal. If the gimbal is required to be in a horizontal shooting mode, the angle of ROLL2 is adjusted to be 0°, that is, joint angles of all motors are controlled to be 0°. If the gimbal is required to be in a vertical-shooting mode, the angle of ROLL2 is adjusted to be 90°, that is, a joint angle of an inner frame motor is controlled to be 90°, and joint angles of a middle frame motor and an outer frame motor are controlled to be 0°. When the gimbal is in a shooting mode, the current attitude is used as an initial attitude in an attitude control mode, the gimbal enters the attitude control mode, and runs normally.

During normal operation, it is determined whether a gimbal centering instruction is received. When the gimbal centering instruction is received, a desired attitude angle for centering is selected based on a control mode, a current attitude angle of the handle portion and a current attitude angle of a camera, and a difference between the desired attitude angle and the current attitude angle of the camera is computed to obtain an attitude angle deviation. A determination of whether the attitude angle deviation satisfies an end condition is then carried out, that is, determining whether the attitude angle deviation is less than a preset deviation threshold. If the attitude angle deviation is less than the preset deviation threshold, the centering ends and the gimbal runs normally. If the attitude angle deviation is greater than the preset deviation threshold, a control instruction is generated based upon the attitude angle deviation, and the gimbal is controlled to return to center based on the control instruction. During the centering process, it is determined whether the centering operation has timed out. If the centering operation does not time out, the gimbal is controlled to continue the centering. If the centering operation times out, the centering operation is forced to terminate, and the gimbal operates normally.

According to the gimbal control method provided by the aforementioned embodiments, the current control mode of the gimbal, the current attitude angle of the handle portion and the current attitude angle of the clamping portion can accurately determine the attitude angle of the gimbal when the centering is completed, and then based on the determined attitude angle and the current attitude angle of the clamping portion, the control instruction for controlling the centering of the gimbal is generated. By executing the control instruction, the gimbal may perform the centering function smoothly without tremor in any attitude, which effectively reduces the problems of the gimbal throwing, hitting the upper limit, or the system crashing, and may accurately and safely control the gimbal to return to center.

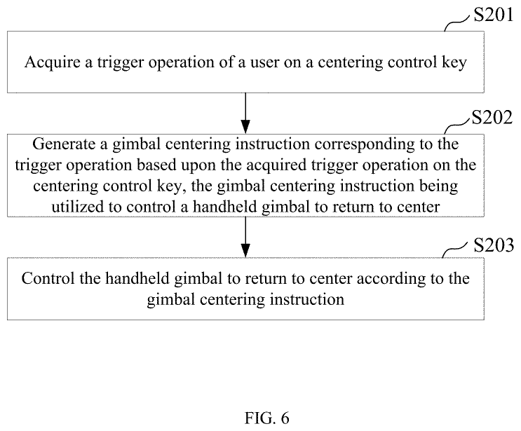

FIG. 6 illustrates a schematic flowchart of another gimbal control method for a gimbal according to some embodiments of the present disclosure. As shown in FIG. 6, the gimbal control method may include steps S201 to S204.

In step S201, a trigger operation of a user on a centering control key is acquired.

In certain embodiments, the gimbal is a handheld gimbal with a non-orthogonal structure. The handheld gimbal is provided with a centering control key. A user may control the gimbal to return to center by triggering the centering control key. The handheld gimbal may detect a user's trigger operation on the centering control key. When the user's trigger operation on the centering control key is detected, the user's trigger operation on the centering control key is acquired. The centering control key may include at least one of a press control key, a joystick control key, a slide control key, or a click control key. The trigger operation may include at least one of a press operation, a joystick operation, a sliding operation or a click operation. It should be noted that the trigger operation and the location of the centering control key may be set based on actual conditions, which are not specifically limited in the present disclosure. In one embodiment, the centering control key is disposed at a handle portion of the gimbal.

In one embodiment, the center control key is also used to control the handheld gimbal to switch between horizontal and vertical shooting modes; and/or the centering control key is also used to control the handheld gimbal to turn on and/or shut down. By setting different control functions to the centering control key, one key may be used for multiple controls, reducing the number of control keys, facilitating a user to control the gimbal, and greatly improving the user experience.

In step S202, a gimbal centering instruction corresponding to the trigger operation is generated based upon the acquired trigger operation on the centering control key, the gimbal centering instruction being utilized to control the handheld gimbal to return to center.

In certain embodiments, the handheld gimbal may include a handle portion, a clamping portion and at least one set of shaft assembly. The shaft assembly may include a motor and a shaft arm. The motor is connected to the shaft arm. The motor is used to drive the shaft arm to rotate. The clamping portion is connected to the shaft arm and rotates with the rotation of the shaft arm, and the clamping portion is used to mount a smart phone, a camera or other imaging equipment.

In one embodiment, when the handheld gimbal generates the gimbal centering instruction corresponding to the trigger operation based upon the trigger operation, where the gimbal centering instruction is utilized to control the handheld gimbal centering. That is, when the handheld gimbal acquires the trigger operation of the user on the centering control key, the handheld gimbal acquires a current control mode of the handheld gimbal, a current attitude angle of the handle portion and a current attitude angle of the clamping portion; determines a target attitude angle of the handheld gimbal based upon the current control mode of the handheld gimbal, the current attitude angle of the handle portion and the current attitude angle of the clamping portion, the target attitude angle being an attitude angle of the handheld gimbal when the centering is completed; and generates the corresponding gimbal centering instruction based upon the target attitude angle and the current attitude angle of the clamping portion.

The method for determining the target attitude angle of the handheld gimbal may include: acquiring a mapping relationship table formed by control modes of the handheld gimbal, attitude angles of the handle portion, and attitude angles of the clamping portion with desired attitude angles, wherein the control modes of the handheld gimbal, the attitude angles of the handle portion and the attitude angles of the clamping portion have a corresponding relationship with the desired attitude angles; and based upon the mapping relationship table, the current control mode of the handheld gimbal, the current attitude angle of the handle portion, and the current attitude of the clamping portion, determining a desired attitude angle of the handheld gimbal, and using the determined desired attitude angle as the target attitude angle of the handheld gimbal. By setting up the mapping relationship table formed by the control modes of the handheld gimbal, the attitude angles of the handle portion and the attitude angles of the clamping portion with the desired attitude angles, the attitude angle of the handheld gimbal after returning to center can be quickly and accurately determined based on the current attitude angles and mode of the handheld gimbal, which facilitates the subsequent generation of accurate and safe gimbal centering instruction to improve the accuracy and safety of returning to center.

In one embodiment, the method of generating the gimbal centering instruction may include: determining an attitude deviation value of the handheld gimbal based on the target attitude angle and the current attitude angle of the clamping portion, that is, calculating an angle difference between the target attitude angle and the current attitude angle and using the angle difference as the attitude deviation value of the handheld gimbal; based upon the attitude deviation value, determining a centering speed of the handheld gimbal, that is, acquiring a pre-stored mapping relationship table between attitude deviation values and centering speeds, and querying the mapping relationship table to obtain a centering speed corresponding to the attitude deviation value of the handheld gimbal, and using the obtained centering speed as the centering speed of the handheld gimbal; and generating the corresponding gimbal centering instruction based upon the centering speed of the handheld gimbal, where the gimbal centering instruction includes the centering speed of the handheld gimbal and an attitude angle of the handheld gimbal when the centering is completed. It should be noted that the larger the attitude deviation value is, the higher the centering speed is, and the smaller the attitude deviation value is, the lower the centering speed is. The handheld gimbal determines the centering speed by the attitude deviation value and generates the gimbal centering instruction corresponding to the centering speed accordingly. Therefore, the centering speed can be adjusted dynamically based on the attitude deviation value, which is convenient for quick control of the gimbal centering, reducing the user waiting time and improving the user experience.

In step S203, the handheld gimbal is controlled to return to center according to the gimbal centering instruction.

After generating the gimbal centering instruction, the handheld gimbal is controlled to return to center according to the gimbal centering instruction, that is, the handheld gimbal obtains the target attitude angle of the handheld gimbal when the centering is completed and the centering speed from the gimbal centering instruction. Based upon the centering speed, the handheld gimbal is controlled to return to center at a constant speed until an attitude angle of the handheld gimbal after returning to center is the target attitude angle. By controlling the gimbal to return to the center at a constant speed, the centering of the gimbal may be carried out smoothly without tremor, which greatly improves the user experience.

In one embodiment, in the process of controlling the centering of the handheld gimbal, the centering speed in the gimbal centering instruction may be updated, and the motor may be controlled to rotate based upon the updated centering speed, and accordingly the gimbal may be controlled to return to center at a variable speed. Specifically, in the process of controlling the centering of the handheld gimbal, an angle difference between the target attitude angle and an attitude angle of the gimbal at a preset time interval after centering is calculated. Then, it is determined whether the angle difference is greater than a preset angle threshold. If the angle difference is greater than the preset angle threshold, the gimbal centering instruction is updated based upon the angle difference, and the handheld gimbal is controlled to return to center based upon the updated gimbal centering instruction. If the angle difference is less than or equal to the preset angle threshold, the gimbal is controlled to end the centering. It should be noted that the preset angle threshold may be set based on actual conditions, which are not specifically limited in the present disclosure. By updating the centering speed in the control instruction at time intervals, it is possible to accelerate the control of the gimbal centering while ensuring stability, which may speed the centering, reduce the user waiting time, and greatly improve the user experience.

The gimbal control method provided in the above embodiments may facilitate a user to control the handheld gimbal to return to center by providing the centering control key, which greatly improves the user experience.

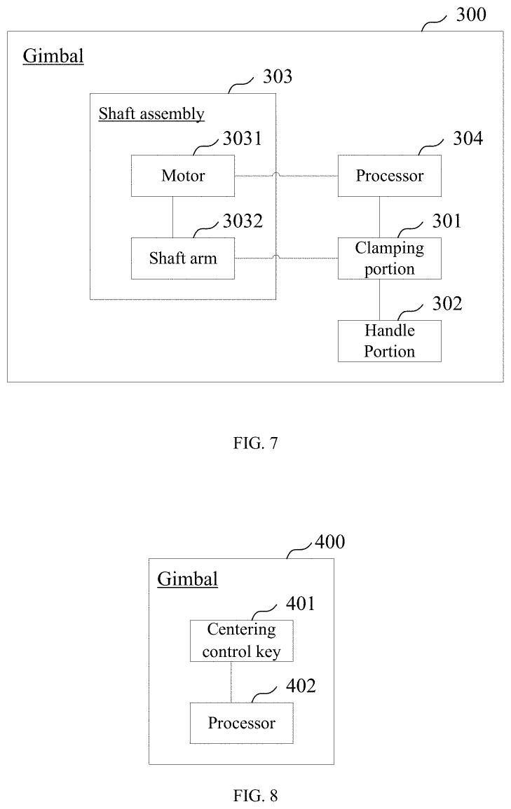

FIG. 7 illustrates a schematic structural block diagram of a gimbal according to some embodiments of the present disclosure. As shown in FIG. 7, the gimbal 300 may include a clamping portion 301, a handle portion 302, and at least one set of shaft assembly 303. The shaft assembly 303 may include a motor 3031 and a shaft arm 3032. The motor 3031 is connected to the shaft arm 3032 to drive the shaft arm 3032 to rotate, and the shaft arm 3032 is connected to the clamping portion 301, which rotates with the rotation of the shaft arm 3032. The gimbal may further include one or more processors 304, at least one of the one or more processors 304 is configured to communicatively connect to the motor 3031.

The one or more processors 304 may be a circuitry, a micro-controller unit (MCU), a central processing unit (CPU), a digital signal processor (digital signal processor, DSP), or the like.

The gimbal may further include a memory (not shown) that is accessible to the one or more processors 304 and/or other components of the gimbal. The memory may be a Flash chip, a read-only memory (ROM), disk, an optical disk, a U disk, a mobile hard disk, or the like.

The one or more processors 304 are, individually or collectively, configured to:

determine a target attitude angle of the gimbal based upon a current control mode of the gimbal, a current attitude angle of the handle portion, and a current attitude angle of the clamping portion, the target attitude angle being an attitude angle of the gimbal when a centering is completed;

determine an attitude deviation value of the gimbal based upon the target attitude angle and the current attitude angle of the clamping portion, and generate a corresponding centering control instruction based upon the attitude deviation value; and

execute the centering control instruction to control the gimbal to return to center until an attitude angle of the clamping portion is the target attitude angle after the centering.

In one embodiment, before the one or more processors 304 are configured to determine the target attitude angle of the gimbal based upon the current control mode of the gimbal, the current attitude angle of the handle portion, and the current attitude angle of the clamping portion, the one or more processors 304 are configured to:

acquire a gimbal centering instruction, where the gimbal centering instruction is used to control the gimbal to return to center; and

acquire the current control mode of the gimbal, the current attitude angle of the handle portion, and the current attitude angle of the clamping portion based upon the gimbal centering instruction.

In one embodiment, when the one or more processors 304 are configured to acquire the gimbal centering instruction, the one or more processors 304 are configured to:

when an attitude angle change process of the handle portion satisfies a preset handle attitude angle change mode, acquire the gimbal centering instruction.

In one embodiment, when the one or more processors 304 are configured to acquire the gimbal centering instruction, the one or more processors 304 are configured to:

when an attitude angle change process of the handle portion satisfies a preset handle attitude angle change mode, and an attitude angle of the clamping portion changes following the attitude angle change process of the handle portion, acquire the gimbal centering instruction.

In one embodiment, the gimbal is provided with a centering control key. When the one or more processors 304 are configured to acquire the gimbal centering instruction, the one or more processors 304 are configured to:

when an acquired trigger operation on the centering control key satisfies a preset trigger operation, acquire the gimbal centering instruction.

In certain embodiments, the centering control key may include at least one of a press control key, a joystick control key, a slide control key, or a click control key; and/or the trigger operation may include at least one of a press operation, a joystick operation, a sliding operation or a click operation.

In one embodiment, when the one or more processors 304 are configured to determine the target attitude angle of the gimbal based upon the current control mode of the gimbal, the current attitude angle of the handle portion, and the current attitude angle of the clamping portion, the one or more processors 304 are configured to:

acquire a mapping relationship table formed by control modes of the gimbal, attitude angles of the handle portion, and attitude angles of the clamping portion, with desired attitude angles, wherein the control modes of the gimbal, the attitude angles of the handle portion and the attitude angles of the clamping portion have a corresponding relationship with the desired attitude angles;

acquire the current control mode of the gimbal, the current attitude angle of the handle portion, and the current attitude angle of the clamping portion; and

determine a desired attitude angle of the gimbal based on the mapping relationship table, the current control mode of the gimbal, the current attitude angle of the handle portion and the current attitude angle of the clamping portion, and set the determined desired attitude angle as the target attitude angle.

In one embodiment, when the one or more processors 304 are configured to determine the desired attitude angle of the gimbal based on the mapping relationship table, the current control mode of the gimbal, the current attitude angle of the handle portion and the current attitude angle of the clamping portion, the one or more processors 304 are configured to:

determine a desired attitude angle tag based on the current control mode of the gimbal, the current attitude angle of the handle portion, and the current attitude angle of the clamping portion; and

according to the mapping relationship table, determine an attitude angle corresponding to the desired attitude angle tag, and set the determined attitude angle as the desired attitude angle of the gimbal.

In one embodiment, when the one or more processors 304 are configured to determine the target attitude angle of the gimbal based upon the current control mode of the gimbal, the current attitude angle of the handle portion, and the current attitude angle of the clamping portion, the one or more processors 304 are configured to:

based upon the current control mode of the gimbal, acquire a mapping relationship table between combined attitude codes corresponding to the handle portion and the clamping portion and desired attitude angles, wherein a control mode of the gimbal has a corresponding relationship with the mapping relationship table:

determine a combined attitude code corresponding to the current attitude angle of the handle portion and the current attitude angle of the clamping portion based upon the current attitude angle of the handle portion and the current attitude angle of the clamping portion; and

according to the mapping relationship table, determine a desired attitude angle corresponding to the determined combined attitude code, and set the determined desired attitude angle as the target attitude angle of the gimbal.

In one embodiment, when the one or more processors 304 are configured to determine the combined attitude code corresponding to the current attitude angle of the handle portion and the current attitude angle of the clamping portion based upon the current attitude angle of the handle portion and the current attitude angle of the clamping portion, the one or more processors 304 are configured to:

acquire a first attitude code corresponding to the current attitude angle of the handle portion and a second attitude code corresponding to the current attitude angle of the clamping portion; and

splice the first attitude code and the second attitude code to obtain a spliced attitude code, and set the spliced attitude code as the combined attitude code.

In one embodiment, when the one or more processors 304 are configured to determine the attitude deviation value of the gimbal based upon the target attitude angle and the current attitude angle of the clamping portion, the one or more processors 304 are configured to:

calculate a difference between the target attitude angle and the current attitude angle of the clamping portion, and set the difference between the target attitude angle and the current attitude angle of the clamping portion as the attitude deviation value of the gimbal.

In one embodiment, when the one or more processors 304 are configured to execute the centering control instruction to control the gimbal to return to center until the attitude angle of the clamping portion after centering is the target attitude angle, the one or more processors 304 are configured to:

in the process of controlling the centering of the gimbal, determine a centering deviation value of the gimbal at a predetermined time interval based on the target attitude angle and the attitude angle of the gimbal after centering at the predetermined time interval;

determine whether the centering deviation value is greater than a preset threshold;

when the centering deviation value is greater than the preset threshold, update the centering control instruction based upon the centering deviation value, and execute the updated centering control instruction to control the gimbal to return to center; or

when the centering deviation value is less than or equal to the preset threshold, determine that the attitude angle of the clamping portion after centering is the target attitude angle, and control the gimbal to end the centering.

In one embodiment, when the one or more processors 304 are configured to update the centering control instruction based upon the centering deviation value, the one or more processors 304 are configured to:

acquire a pre-stored mapping relationship table between centering deviation values and centering speeds:

set a centering speed corresponding to the centering deviation value as an updated centering speed of the gimbal based upon the mapping relationship table; and

update the centering control instruction based upon the updated centering speed of the gimbal.

In one embodiment, before the one or more processors 304 are configured to update the centering control instruction based upon the centering speed of the gimbal, the one or more processors 304 are further configured to:

determine whether the centering speed of the gimbal is less than a preset speed threshold; and

when the centering speed of the gimbal is less than the preset speed threshold, update the centering control instruction based upon the centering speed of the gimbal.

In one embodiment, the one or more processors 304 are further configured to:

when controlling the gimbal to return to center, record a centering duration of the gimbal, and determine whether the centering duration of the gimbal is greater than a preset time threshold; and

when the centering duration is greater than the preset time threshold, control the gimbal to end the centering.

In some embodiments, the clamping portion is provided with an inertial measurement unit, the current attitude angle of the clamping portion is determined by the inertial measurement unit, and the current attitude angle of the handle portion is determined based on the current attitude angle of the clamping portion.

In some embodiments, the clamping portion and the handle portion are each provided with an inertial measurement unit, and the current attitude angle of the clamping portion and the current attitude angle of the handle portion are determined by their corresponding inertial measurement units provided.

In some embodiments, the gimbal is a gimbal with a non-orthogonal structure.

It should be noted that those skilled in the art may clearly understand that for the convenience and brevity of the description, the specific operating process of the above-described gimbal may refer to the corresponding process in the aforementioned gimbal control method embodiments, which will not be repeated herein for conciseness.

FIG. 8 illustrates a schematic structural block diagram of a gimbal according to some embodiments of the present disclosure. As shown in FIG. 8, the gimbal 400 may include a centering control key 401 and one or more processors 402, wherein at least one of the one or more processors 402 is configured to communicatively connect to the centering control key 401.

The one or more processors 402 may be a circuitry, a micro-controller unit (MCU), a central processing unit (Central Processing Unit, CPU), a digital signal processor (Digital Signal Processor, DSP), or the like.

The one or more processors 402 are, individually or collectively, configured to:

acquire a trigger operation of a user on the centering control key;

generate a gimbal centering instruction corresponding to the trigger operation based upon the acquired trigger operation of the user on the centering control key, the gimbal centering instruction being used to control the gimbal to return to center; and

control the gimbal to return to center according to the gimbal centering instruction.

In certain embodiments, the centering control key may include at least one of a press control key, a joystick control key, a slide control key, or a click control key; and/or,

the trigger operation may include at least one of a pressing operation, a joystick operation, a sliding operation, or a clicking operation; and/or,

the centering control key is used to control the gimbal to switch between horizontal and vertical shooting modes; and/or,

the centering control key is used to control the gimbal to turn on and/or turn off.

In some embodiments, the gimbal is a gimbal with a non-orthogonal structure.

In some embodiments, when the one or more processors 402 are configured to generate the gimbal centering instruction corresponding to the trigger operation based upon the acquired trigger operation of the user on the centering control key, the one or more processors 402 are configured to:

when the trigger operation of the user on the centering control key is acquired, acquire a current control mode of the gimbal, a current attitude angle of a handle portion of the gimbal and a current attitude angle of a clamping portion of the gimbal;

determine a target attitude angle of the gimbal based upon the current control mode of the gimbal, the current attitude angle of the handle portion of the gimbal, and the current attitude angle of the clamping portion of the gimbal, the target attitude angle being an attitude angle of the gimbal when a centering is completed; and

generate a corresponding gimbal centering instruction based upon the target attitude angle and the current attitude angle of the clamping portion.

In some embodiments, when the one or more processors 402 are configured to generate the corresponding gimbal centering instruction based upon the target attitude angle and the current attitude angle of the clamping portion, the one or more processors 402 are configured to:

determine an attitude deviation value of the gimbal based upon the target attitude angle and the current attitude angle of the clamping portion; and

based upon the attitude deviation value, determine a centering speed of the gimbal, and generate the corresponding gimbal centering instruction based upon the centering speed of the gimbal.

It should be noted that those skilled in the art may clearly understand that for the convenience and brevity of the description, the specific operating process of the above-described gimbal may refer to the corresponding process in the control method embodiments disclosed above, which will not be repeated herein for conciseness.

The present disclosure also provides a computer-readable storage medium, the computer-readable storage medium stores a computer program, which includes program instructions. When the computer program is executed by a processor, at least some steps of the gimbal control methods disclosed in the present disclosure are implemented.

The computer-readable storage medium may be an internal storage unit of the gimbal described in any of the foregoing embodiments, such as a hard disk or memory of the gimbal. The computer-readable storage medium may also be an external storage device of the gimbal, such as a plug-in hard disk equipped on the gimbal, a smart media card (SMC), and a secure digital card (SD), a Flash Card, etc.

Each part of the present disclosure may be implemented by hardware, software, firmware, or a combination thereof. In the above exemplary embodiments, multiple steps or methods may be implemented by hardware or software stored in a memory and executed by a suitable instruction execution system. For example, if it is realized by hardware, it may be realized by any one of the following technologies or a combination thereof: discrete logic circuits with logic gates for realizing logic functions on data signals, and dedicated integrated circuits with suitable combinational logic gate circuits, a programmable gate array (PGA), a field programmable gate array (FPGA), etc.

The computer readable storage medium may be a tangible device that can store programs and instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations); flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the device/systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

The processor may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

The memory and non-volatile storage medium may be computer-readable storage media. The memory may include any suitable volatile storage devices such as dynamic random-access memory (DRAM) and static random access memory (SRAM). The non-volatile storage medium may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

The program may be a collection of machine-readable instructions and/or data that is stored in non-volatile storage medium and is used to create, manage and control certain software functions that are discussed in detail elsewhere in the present disclosure and illustrated in the drawings. In some embodiments, the memory may be considerably faster than the non-volatile storage medium. In such embodiments, the program may be transferred from the non-volatile storage medium to the memory prior to execution by a processor.

Those skilled in the art will appreciate that all or parts of the steps disclosed in the methods, devices and systems of the instant disclosure may be implemented by instructing the relevant hardware through a program, and the program may be stored in a computer-readable storage medium. When the program is executed, it includes one or a combination of the steps of the method embodiments disclosed herein.

The terms used herein are only for the purpose of describing specific embodiments, and are not intended to limit of the disclosure. As used in this disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items. Terms such as “connected” or “linked” are not limited to physical or mechanical connections, and may include electrical connections, whether direct or indirect. Relational terms such as “first” and “second”, etc. are used herein merely to distinguish one entity or operation from another entity or operation without necessarily requiring or implying any such actual relationship or order between such entities or operations. The terms “comprise/comprising”, “include/including”, “has/have/having” or any other variants thereof are intended to cover non-exclusive inclusion, so that a process, method, article, or device that includes a series of elements includes not only those elements, but also other elements that are not explicitly listed, or also includes elements inherent to such processes, methods, articles, or equipment. If there are no more restrictions, the element defined by the phrase, such as “comprising a . . . ”, “including a . . . ” does not exclude the presence of additional identical elements in the process, method, article, or equipment that includes the element.

Finally, it should be noted that the above embodiments/examples are only used to illustrate the technical features of the present disclosure, not to limit them; although the present disclosure has been described in detail with reference to the foregoing embodiments and examples, those of ordinary skill in the art should understand that: the technical features disclosed in the foregoing embodiments and examples can still be modified, some or all of the technical features can be equivalently replaced, but, these modifications or replacements do not deviate from the spirit and scope of the disclosure.

What is claimed is:

1. A gimbal control method, comprising:
determining a target attitude angle of a gimbal based upon a current control mode of the gimbal, a current attitude angle of a handle portion of the gimbal, and a current attitude angle of a clamping portion of the gimbal, the target attitude angle being an attitude angle of the gimbal at a center position;
determining an attitude deviation value of the gimbal based upon the target attitude angle and the current attitude angle of the clamping portion, and generating a corresponding centering control instruction based upon the attitude deviation value; and
executing the centering control instruction to control the gimbal to return to the center position until an attitude angle of the clamping portion is the target attitude angle after centering.

2. The gimbal control method of claim 1, wherein before determining the target attitude angle of the gimbal based upon the current control mode of the gimbal, the current attitude angle of the handle portion, and the current attitude angle of the clamping portion, the gimbal control method further comprises:
acquiring a gimbal centering instruction, the gimbal centering instruction being configured to control the gimbal to return to the center position; and
acquiring the current control mode of the gimbal, the current attitude angle of the handle portion, and the current attitude angle of the clamping portion based upon the gimbal centering instruction.

3. The gimbal control method of claim 2, wherein the acquiring the gimbal centering instruction comprises:
when an attitude angle change process of the handle portion satisfies a preset handle attitude angle change mode, acquiring the gimbal centering instruction.

4. The gimbal control method of claim 3, wherein the acquiring the gimbal centering instruction comprises:
when the attitude angle change process of the handle portion satisfies the preset handle attitude angle change mode and an attitude angle of the clamping portion changes following the attitude angle change process of the handle portion, acquiring the gimbal centering instruction.

5. The gimbal control method of claim 2, wherein the gimbal comprises a centering control key; and the acquiring the gimbal centering instruction comprises:
when an acquired trigger operation on the centering control key satisfies a preset trigger operation, acquiring the gimbal centering instruction.

6. The gimbal control method of claim 5, wherein the centering control key is at least one selected from the group consisting of a press control key, a joystick control key, a slide control key, a click control key, and combinations thereof; and/or the trigger operation comprises at least one selected from the group consisting of a press operation, a joystick operation, a sliding operation, a click operation, and combinations thereof.

7. The gimbal control method of claim 1, wherein the determining the target attitude angle of the gimbal based upon the current control mode of the gimbal, the current attitude angle of the handle portion of the gimbal, and the current attitude angle of the clamping portion of the gimbal comprises:
acquiring a mapping relationship table of control modes of the gimbal, attitude angles of the handle portion of the gimbal, and attitude angles of the clamping portion of the gimbal with desired attitude angles, wherein the control modes of the gimbal, the attitude angles of the handle portion of the gimbal and the attitude angles of the clamping portion of the gimbal have corresponding relationship with the desired attitude angles;
acquiring the current control mode of the gimbal, the current attitude angle of the handle portion of the gimbal, and the current attitude angle of the clamping portion of the gimbal; and
determining a desired attitude angle of the gimbal based upon the mapping relationship table, the current control mode of the gimbal, the current attitude angle of the handle portion of the gimbal and the current attitude angle of the clamping portion of the gimbal, and setting the determined desired attitude angle as the target attitude angle.

8. The gimbal control method of claim 7, wherein the determining the desired attitude angle of the gimbal based upon the mapping relationship table, the current control mode of the gimbal, the current attitude angle of the handle portion of the gimbal and the current attitude angle of the clamping portion of the gimbal comprises:
determining a desired attitude angle tag based upon the current control mode of the gimbal, the current attitude angle of the handle portion of the gimbal, and the current attitude angle of the clamping portion of the gimbal; and
determining an attitude angle corresponding to the desired attitude angle tag according to the mapping relationship table, and setting the determined attitude angle as the desired attitude angle of the gimbal.

9. The gimbal control method of claim 1, wherein the determining the target attitude angle of the gimbal based upon the current control mode of the gimbal, the current attitude angle of the handle portion of the gimbal, and the current attitude angle of the clamping portion of the gimbal comprises:
based upon the current control mode of the gimbal, acquiring a mapping relationship table between combined attitude codes corresponding to the handle portion and the clamping portion and desired attitude angles, wherein a control mode of the gimbal has a corresponding relationship with the mapping relationship table;
determining a combined attitude code corresponding to the current attitude angle of the handle portion of the gimbal and the current attitude angle of the clamping portion of the gimbal based upon the current attitude angle of the handle portion of the gimbal and the current attitude angle of the clamping portion of the gimbal; and
according to the mapping relationship table, determining a desired attitude angle corresponding to the determined combined attitude code, and setting the determined desired attitude angle as the target attitude angle of the gimbal.

10. The gimbal control method of claim 9, wherein the determining the combined attitude code corresponding to the current attitude angle of the handle portion of the gimbal and the current attitude angle of the clamping portion of the gimbal based upon the current attitude angle of the handle portion of the gimbal and the current attitude angle of the clamping portion of the gimbal comprises:
acquiring a first attitude code corresponding to the current attitude angle of the handle portion of the gimbal and a second attitude code corresponding to the current attitude angle of the clamping portion of the gimbal; and
splicing the first attitude code and the second attitude code to obtain a spliced attitude code, and setting the spliced attitude code as the combined attitude code.

11. The gimbal control method of claim 1, wherein the determining the attitude deviation value of the gimbal based upon the target attitude angle and the current attitude angle of the clamping portion of the gimbal comprises:
computing a difference between the target attitude angle and the current attitude angle of the clamping portion of the gimbal; and
setting the computed difference between the target attitude angle and the current attitude angle of the clamping portion as the attitude deviation value of the gimbal.

12. The gimbal control method of claim 1, wherein the executing the centering control instruction to control the gimbal to return to the center position until the attitude angle of the clamping portion is the target attitude angle after centering comprises:
in the process of controlling the gimbal to return to the center position, determining a centering deviation value of the gimbal based on the target attitude angle and the attitude angle of the gimbal at a predetermined time interval after the centering;
determining whether the centering deviation value is greater than a preset threshold;
when the centering deviation value is greater than the preset threshold, updating the centering control instruction based upon the centering deviation value, and executing the updated centering control instruction to control the gimbal to return to the center position; or
when the centering deviation value is less than or equal to the preset threshold, determining that the attitude angle of the clamping portion of the gimbal after the centering is the target attitude angle, and controlling the gimbal to end the centering.

13. The gimbal control method of claim 12, wherein the updating the centering control instruction based upon the centering deviation value comprises:
acquiring a pre-stored mapping relationship table between centering deviation values and centering speeds;
setting a centering speed corresponding to the centering deviation value as an updated centering speed of the gimbal based upon the pre-stored mapping relationship table; and
updating the centering control instruction based upon the updated centering speed of the gimbal.

14. The gimbal control method of claim 1, further comprising:
during a process of controlling the gimbal to return to the center position, recording a centering duration of the gimbal, and determining whether the centering duration of the gimbal is greater than a preset time threshold; and
when the centering duration is greater than the preset time threshold, controlling the gimbal to end the centering.

15. The gimbal control method of claim 1, wherein the clamping portion of the gimbal comprises an inertial measurement unit, the current attitude angle of the clamping portion of the gimbal is determined by the inertial measurement unit, and the current attitude angle of the handle portion of the gimbal is determined based on the current attitude angle of the clamping portion of the gimbal.

16. The gimbal control method of claim 1, wherein the clamping portion of the gimbal and the handle portion of the gimbal each comprise an inertial measurement unit, the current attitude angle of the clamping portion of the gimbal and the current attitude angle of the handle portion of the gimbal are each determined by the corresponding inertial measurement unit thereof.

17. The gimbal control method of claim 1, wherein the gimbal is a gimbal with a non-orthogonal structure.

18. A gimbal control method for a handheld gimbal comprising a centering control key, comprising:
acquiring a trigger operation of a user on the centering control key;
generating a gimbal centering instruction corresponding to the trigger operation based upon the acquired trigger operation of the user on the centering control key, the gimbal centering instruction being configured to control the handheld gimbal to return to a center position; and
controlling the handheld gimbal to return to the center position according to the gimbal centering instruction.

19. A gimbal, comprising:
a clamping portion;
a handle portion;
at least one set of shaft assembly, the shaft assembly comprising a motor and a shaft arm, the motor being connected to the shaft arm for driving the shaft arm to rotate, the shaft arm being connected to the clamping portion, and the clamping portion rotating with rotation of the shaft arm, and
one or more processors, at least one of the one or more processors configured to communicatively connect to the motor, wherein the one or more processors are, individually or collectively, configured to:
determine a target attitude angle of the gimbal based upon a current control mode of the gimbal, a current attitude angle of the handle portion and a current attitude angle of the clamping portion, the target attitude angle being an attitude angle of the gimbal at a center position;
determine an attitude deviation value of the gimbal based upon the target attitude angle and the current attitude angle of the clamping portion, and generate a corresponding centering control instruction based upon the attitude deviation value; and
execute the centering control instruction to control the gimbal to return to the center position until an attitude angle of the clamping portion is the target attitude angle after centering.

20. The gimbal of claim 19, wherein when the one or more processors are configured to determine the target attitude angle of the gimbal based upon the current control mode of the gimbal, the current attitude angle of the handle portion and the current attitude angle of the clamping portion, the one or more processors are configured to:
based upon the current control mode of the gimbal, acquire a mapping relationship table between combined attitude codes corresponding to the handle portion and the clamping portion and desired attitude angles, wherein a control mode of the gimbal has a corresponding relationship with the mapping relationship table;
determine a combined attitude code corresponding to the current attitude angle of the handle portion and the current attitude angle of the clamping portion based upon the current attitude angle of the handle portion and the current attitude angle of the clamping portion; and
according to the mapping relationship table, determine a desired attitude angle corresponding to the determined combined attitude code, and set the determined desired attitude angle as the target attitude angle of the gimbal.
